(19) United States
(12) Patent Application Publication
(10) Pub. No.: US 2020/0319044 A1
(43) Pub. Date: Oct. 8, 2020

(54) HOOF PRESSURE MEASURING SYSTEM

(71) Applicants: Ann Ramsey, Davis, CA (US); Matthew Seitzler, Davis, CA (US)

(72) Inventors: Ann Ramsey, Davis, CA (US); Matthew Seitzler, Davis, CA (US)

(21) Appl. No.: 16/377,771

(22) Filed: Apr. 8, 2019

(51) Int. Cl. G01L 5/16; A01L 3/00; A01L 7/00; A01K 29/00

(52) U.S. Cl. CPC G01L 5/161; A01L 3/00; A01K 13/007; A01K 29/005; A01L 7/00

(57) ABSTRACT

A hoof pressure measuring system is configured to wirelessly communicate pressure of a horse's hoof to a remote device. The hoof pressure measuring system has a plurality of pressure application cylinders is arranged on a thickened ledge in a top plate. A bottom plate is joined to the top plate, and further includes a bottom plate wire cavity that penetrates the bottom plate and is arranged thinner than a peripheral wall ledge. A plurality of resistive force measurement sensors is arranged between the plurality of sensor location cavities and the plurality of pressure application cylinders. A microprocessor is electrically coupled to the plurality of resistive force measurement sensors and is programmed with instructions to measure an array of force measurements with respect to time from the plurality of pressure application cylinders. Force measurement data is wirelessly transmitted to remote viewing devices via Bluetooth or other communication protocols.

### BACKGROUND

The present invention relates generally to the wireless hoof pressure mapping for equine quadraped using a sensor system encapsulated within a lightweight flexible structure worn under the hoof in conjunction with a horse hoof shoe.

Previous articles provided by Fullen et al provided a general pressure measurement system for the equine hoof, however this system proposed the use of a wired device, with external wires that had to be attached to the horses distal limb and body. This design is more cumbersome to install, as both sensors and electronics enclosures with attached wiring, must be taped to the lateral side of the equine distal limb. This use of external wiring makes the system more vulnerable to damage from objects or debris in the testing environment, as well as damage caused by interference from the horses other limbs or the body itself. The presence of exterior wiring could affect the movement of the horse's limb as proprioception is altered due to the taped wires touching the skin. This could be particularly disruptive to measurements and accuracy, especially if only one leg is tapped with wires. Animals will alter their gait and limb flight pattern based on the placement of external proprioceptive stimulation. Removing the external wiring could eliminate the potential variable of proprioceptive interference in normal ambulatory function of the animal.

The problem is that the previous articles do not provide a robust, fully wireless, and accurate measurement system to measure equine hoof pressure without being bulky and introducing installation and operational safety issues.

The solution provided by the prior art is the general location of a sensor and force measurement apparatus sensor below the equine foot which then needs to be wired to electronics enclosure for wireless communication. These designs used either a rigid three-dimensional measurement system or a flexible two-dimensional system.

Other solutions provided by the prior art are the potential additional measurement locations, but these designs were never proven to function under the high and frequency loading provided by the equine hoof.

These approaches don't work well, for the reason that they did not provide for both a robust measurement system and one that is flexible enough to measure the difference between specific regions of hoof pressure resulting from contact of specific anatomy of the horse. These regions needed to accurately determine ambulatory function in the equine hoof are the hoof wall, center frog, etc.

Thus, there is a continuing need to provide a solution that will overcome the problems of gait influence caused by rigid measurement systems and wires connected to the equine limb. The design of a robust long-term measurement system instead requires a system rigid enough to protect the sensor system, while being flexible enough to accurately discern between forces induced from specific parts of the equine anatomy on the foot. A fully wireless system using new technology both in the microprocessor and data acquisition as well as the transmission and force sensoring can meet this need.

### SUMMARY

The present invention is a hoof pressure measuring system which is configured to communicate pressure of a horse's hoof. The hoof pressure measuring system comprises a top plate, further comprising a raised outer edge. A thickened ledge is adjacent to the raised outer edge. A top plate wire cavity penetrates the top plate and is arranged thinner than the thickened ledge. A plurality of pressure application cylinders is arranged on the thickened ledge. A bottom plate is joined to the top plate, and further comprises a peripheral wall ledge. A plurality of sensor location cavities is arranged on the peripheral wall ledge. A bottom plate wire cavity penetrates the bottom plate, and arranged thinner than the peripheral wall ledge. A plurality of resistive force measurement sensors is arranged between the plurality of sensor location cavities and the plurality of pressure application cylinders arranged. A battery is arranged between the top plate wire cavity and the bottom plate wire cavity.

A microprocessor is electrically coupled to the plurality of pressure application cylinders and to the battery. The microprocessor is communicatively coupled to the plurality of resistive force measurement sensors. The microprocessor is communicatively coupled to a communication device and programmed with instructions to perform the following steps. First measure an array of force measurements with respect to time from the plurality of pressure application cylinders. Then, communicate the array of force measurements and other metrics including but not limited to the center-of-pressure, lateral force vectors, and compressive force vectors, and pressure vectors to the remote communication device or computer via the microprocessor communication device.

In some embodiments a signal conditioning circuit is electrically coupled to the plurality of resistive force measurement sensors. A first voltage regulator is electrically coupled to the signal conditioning circuit and configured to provide a reference voltage. At least one operational amplifier is electrically coupled to the first voltage regulator, a second voltage regulator, and one of the plurality of resistive force measurement sensors. Measuring a difference between the reference voltage and a second voltage from the second voltage regulator determines the pressure on the one of the plurality of resistive force measurement sensors.

In some embodiments, a top plate opening is arranged through the top plate. A bottom plate opening is arranged through the bottom plate. A top compression bolt is joined through the top plate opening. A bottom nut is arranged against the bottom plate opening. The top compression bolt is joined to the bottom nut in order to operatively connect the top plate to the bottom plate. The top plate and the bottom plate are operatively connected such that the top plate. can separate from the bottom plate a distance of at least one ten thousandth of one inch but no more than one hundredth of one inch. This enables the movement of the top and bottom plates while providing for the full encapsulation of the sensors and device electronics away from the horse's hoof and the horse hoof shoe. In some embodiments, the raised outer edge operatively surrounds the peripheral wall ledge in order to prevent lateral movement of the top plate and the bottom plate.

In some embodiments, the plurality of pressure application cylinders further comprises a lateral heel pressure application cylinder, arranged in a lateral heel pressure application cylinder cavity. The plurality of sensor location cavities further comprises a lateral heel sensor location cavity. A lateral heel resistive force measurement sensor is arranged in the lateral heel sensor location cavity. The lateral heel resistive force measurement sensor is electrically coupled to the at least one operational amplifier.

In sonic embodiments, the plurality of pressure application cylinders further comprises a caudal heel pressure application cylinder, arranged in a caudal heel pressure application cylinder cavity. The plurality of sensor location cavities further comprises a caudal heel sensor location cavity A caudal heel resistive force measurement sensor is arranged in the caudal heel sensor location cavity. The caudal heel resistive force measurement sensor is electrically coupled to the at least one operational amplifier.

In some embodiments, the caudal heel sensor location cavity further comprises a caudal heel sensor location top edge arranged on a caudal heel sensor location top edge axis. The bottom plate further comprises a bottom plate wire cavity caudal heel axis. A caudal heel sensor location cavity angle is measured clockwise from the caudal heel sensor location top edge axis to the bottom plate wire cavity caudal heel axis. The caudal heel sensor location cavity angle is at least five degrees hut no more than thirty degrees.

In some embodiments, the plurality of pressure application cylinders further comprises a medial heel pressure application cylinder, arranged in a medial heel pressure application cylinder cavity. The plurality of sensor location cavities further comprises a medial heel sensor location cavity. A medial heel resistive force measurement sensor is arranged in the medial heel sensor location cavity. The medial heel resistive force measurement sensor is electrically coupled to the at least one operational amplifier.

In some embodiments, the plurality of sensor location cavities further comprises a frog pressure application cylinder cavity. A frog pressure application cylinder is arranged in the frog pressure application cylinder cavity. The plurality of sensor location cavities further comprises: a frog sensor location cavity. A frog resistive force measurement sensor is arranged in the frog sensor location cavity. The frog resistive force measurement sensor is electrically coupled to the at least one operational amplifier.

In some embodiments, the plurality of pressure application cylinders further comprises a lateral quarter pressure application cylinder, arranged in a lateral quarter pressure application cylinder cavity. The plurality of sensor location cavities further comprises: a lateral quarter sensor location cavity. A lateral quarter resistive force measurement sensor is arranged in the lateral quarter sensor location cavity. The lateral quarter resistive force measurement sensor is electrically coupled to the at least one operational amplifier.

In some embodiments, the lateral quarter sensor location cavity further comprises a lateral quarter sensor location top edge arranged on a lateral quarter sensor location top edge axis. The bottom plate further comprises a bottom plate wire cavity lateral quarter axis. A lateral quarter sensor location cavity angle is measured clockwise from the lateral quarter sensor location top edge axis to the bottom plate wire cavity lateral quarter axis. The lateral quarter sensor location cavity angle is at least five degrees but no more than thirty degrees.

In some embodiments, the plurality of pressure application cylinders further comprises a medial quarter pressure application cylinder, arranged in a medial quarter pressure application cylinder cavity. The plurality of sensor location cavities further composes: a medial quarter sensor location cavity. A medial quarter resistive force measurement sensor is arranged in the medial quarter sensor location cavity. The medial quarter resistive force measurement sensor is electrically coupled to the at least one operational amplifier.

In some embodiments, the medial quarter sensor location cavity further comprises a medial quarter sensor location top edge arranged on a medial quarter sensor location top edge axis. The bottom plate further comprises a bottom plate wire cavity lateral quarter axis. A medial quarter sensor location cavity angle is measured clockwise from the medial quarter sensor location top edge axis to the bottom plate wire cavity lateral quarter axis. The medial quarter sensor location cavity angle is at least five degrees but no more than thirty degrees.

In some embodiments, the plurality of pressure application cylinders further comprises a lateral toe pressure application cylinder, arranged in a lateral toe pressure application cylinder cavity. The plurality of sensor location cavities further comprises a lateral toe sensor location cavity. A lateral toe resistive force measurement sensor is arranged in the lateral toe sensor location cavity. The lateral toe resistive force measurement sensor is electrically coupled to the at least one operational amplifier.

In some embodiments, the plurality of pressure application cylinders further comprises a dorsal toe, pressure application cylinder, arranged in a dorsal toe pressure application cylinder cavity. The plurality of sensor location cavities further comprises: a dorsal toe sensor location cavity. A dorsal toe resistive force measurement sensor is arranged in the dorsal toe sensor location cavity. The dorsal toe resistive force measurement sensor is electrically coupled to the at least one operational amplifier.

In some embodiments, the dorsal toe sensor location cavity further comprises a dorsal toe sensor location top edge arranged on a dorsal toe sensor location top edge axis. The bottom plate further comprises a bottom plate, wire cavity dorsal toe axis. A dorsal toe sensor location cavity angle is measured clockwise from the dorsal toe sensor location top edge axis to the bottom plate wire cavity dorsal toe axis. The dorsal toe sensor location cavity angle is at least five degrees but no more than thirty degrees.

In some embodiments, the plurality of pressure application cylinders further comprises a medial toe pressure application cylinder, arranged in a medial toe pressure application cylinder cavity. The plurality of sensor location cavities further comprises a medial toe sensor location cavity. A medial toe resistive force measurement sensor is arranged in the medial toe sensor location cavity. The medial toe resistive force measurement sensor is electrically coupled to the at least one operational amplifier.

### BRIEF DESCRIPTION OF THE FIGURES

The detailed description of some embodiments of the invention is made below with reference to the accompanying figures, wherein like numerals represent corresponding parts of the figures.

FIG. 1 shows an orthographic view of an embodiment of the present invention along with a horse hoof and horse boot;

FIG. 2 shows an elevation view of an embodiment of the present invention with section view for FIG. 3;

FIG. 3 shows the section view aligned with the medial and lateral axis through an embodiment of the present invention taken along line 3-3 in FIG. 2;

FIG. 3A shows a detail view of an embodiment of the present invention;

FIG. 4 shows an orthographic view of the bottom plate an embodiment of the present invention;

FIG. 5 shows an orthographic assembly view of the top plate including pressure application cylinders, and top compression nut for an embodiment of the present invention;

FIG. 6 shows an orthographic assembly view of the top plate assembly, bottom plate, and remaining components comprising an embodiment of the present invention;

FIG. 7 shows an elevation view of an embodiment of the present invention.

FIG. 8 shows the section view aligned with the medial and lateral axis through an embodiment of the present invention shown in FIG. 7 as well as detail view locations for FIG. 8A and 8B;

FIG. 8A shows a detail view of an embodiment of the present invention;

FIG. 8B shows a detail view of an embodiment of the present invention;

FIG. 9 shows an elevation view of an embodiment of the present invention.

FIG. 10 shows the section view aligned with the dorsal toe and caudal heel axis through an embodiment of the present invention shown in FIG. 9 as well as detail view locations for FIG. 10A and 10B;

FIG. 10A shows the detail view of an embodiment of the present invention in FIG. 10;

FIG. 10B shows the detail view of an embodiment of the present invention FIG. 10;

FIG. 11 shows an orthographic view of the bottom plate of an embodiment of the present invention;

FIG. 12 shows an orthographic assembly view of the top plate including pressure application cylinders, and top compression nut for an embodiment of the present invention;

FIG. 13 shows an orthographic assembly view of the top plate assembly, bottom plate, and remaining components comprising an embodiment of the present invention;

FIG. 14 shows the hoof anatomy generally.

### DETAILED DESCRIPTION OF CERTAIN EMBODIMENTS

FIG. 14 provides a general rendition of horse anatomy. H: is a horse's hoof H10, includes regions of the lateral heel H1, caudal heel H2, medial heel H3, lateral quarter H5, medial quarter H6, lateral toe H7, dorsal toe H8, and medial toe H9.

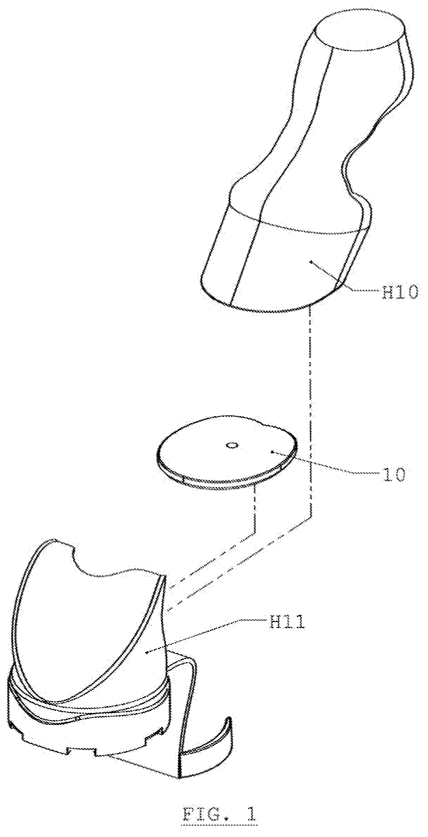

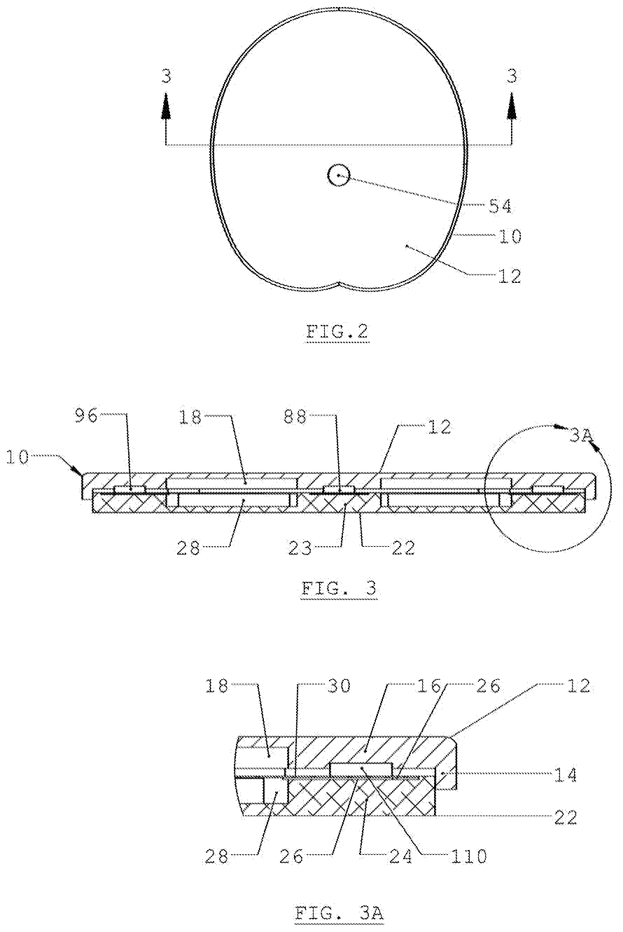

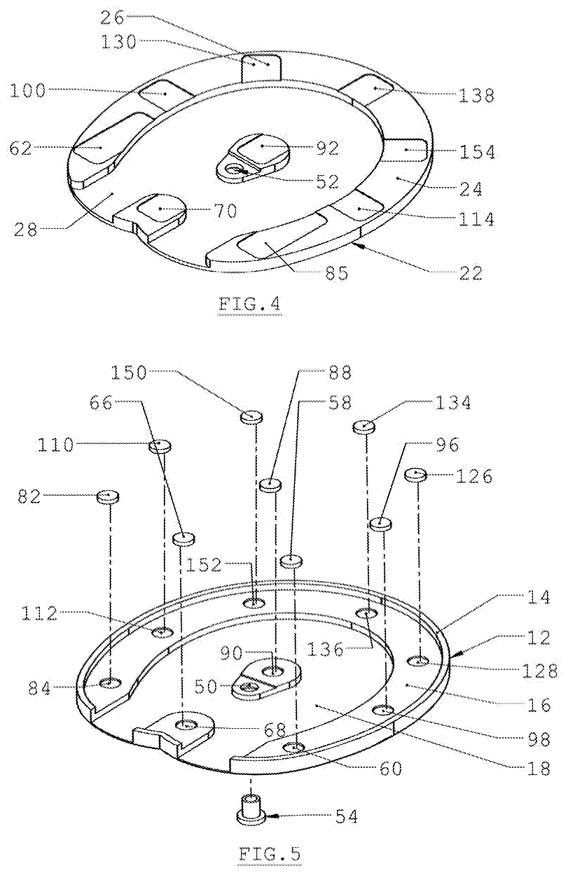

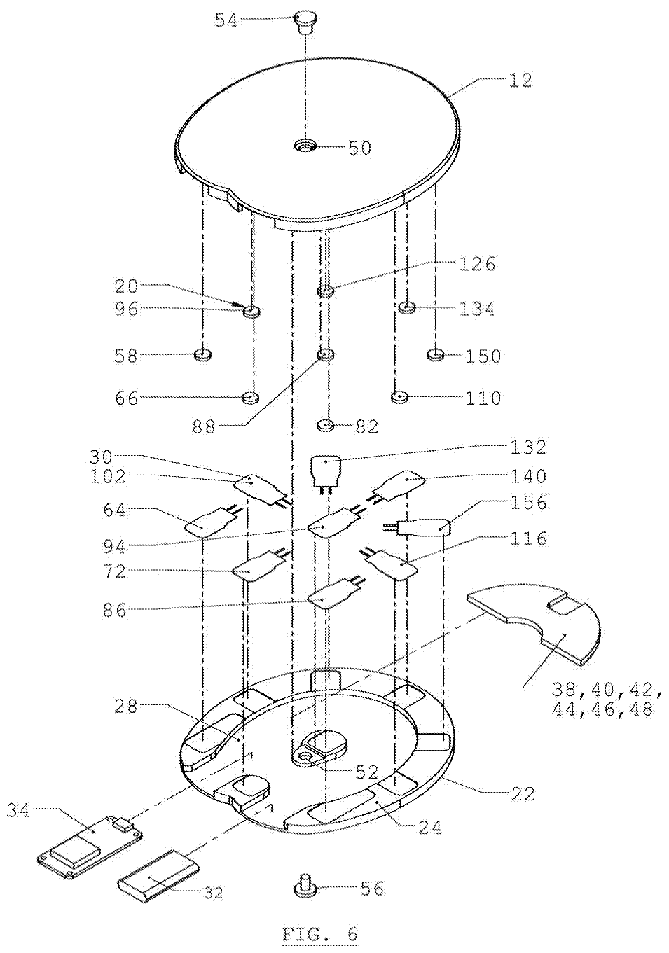

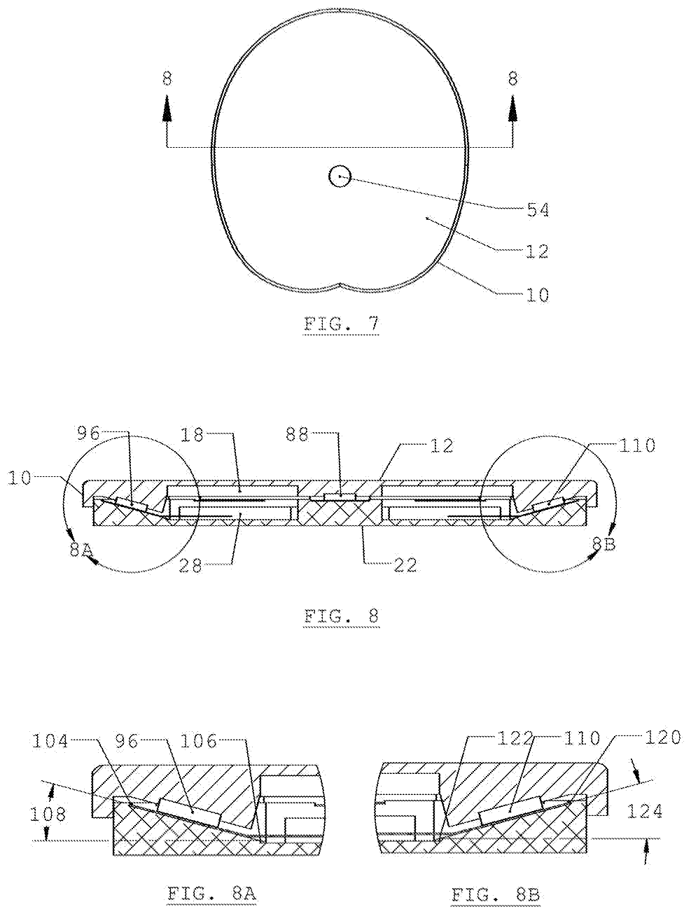

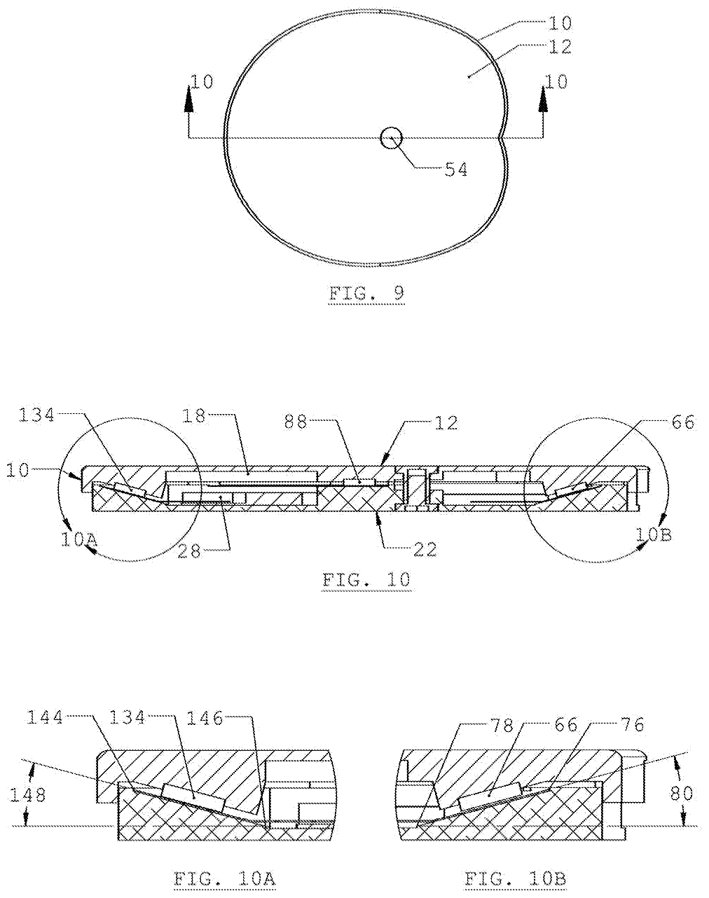

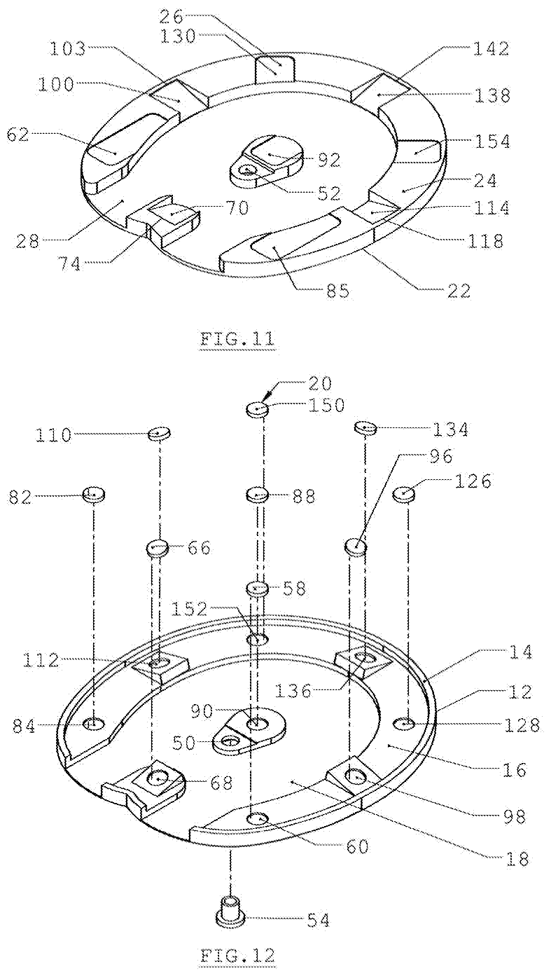

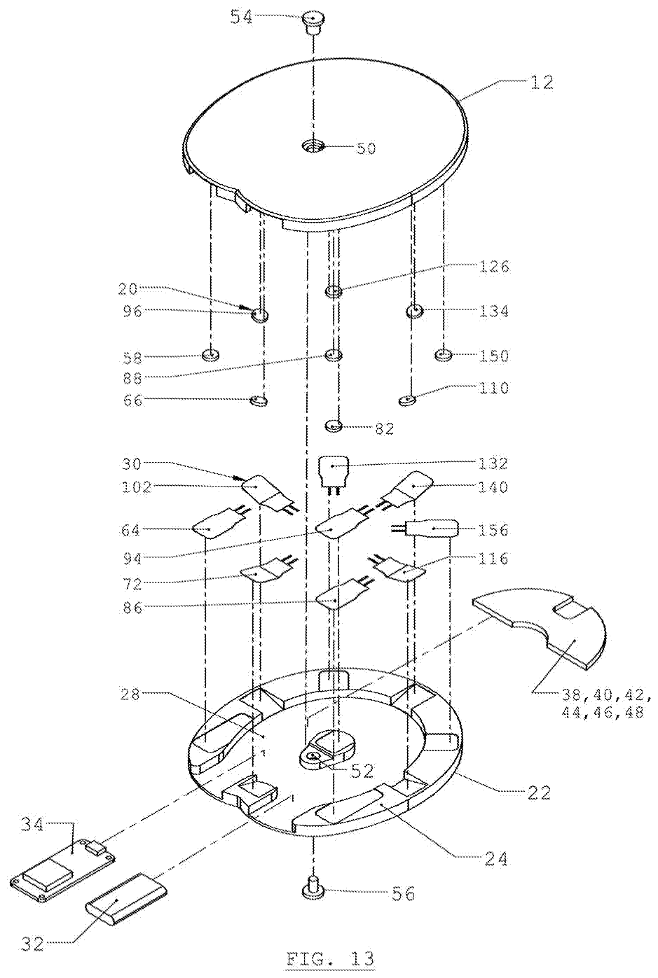

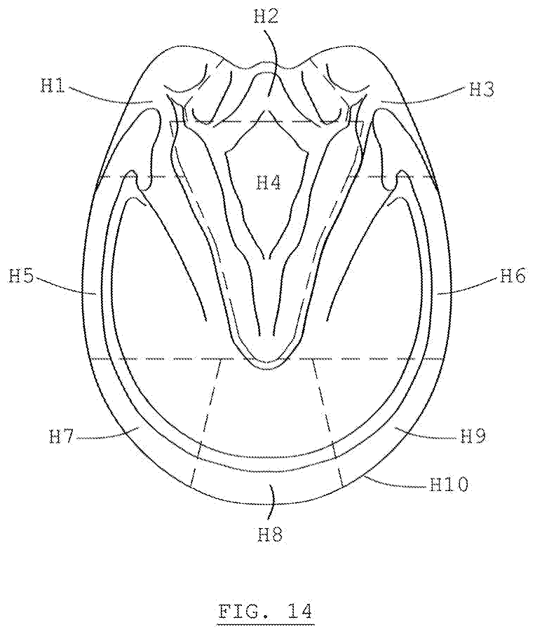

Turning to FIGS. 1-13, a hoof pressure measuring system 10 is configured to communicate pressure of a horse's hoof. The hoof pressure measuring system 10 comprises a top plate 12, further comprising a raised outer edge 14, A thickened ledge 16 is adjacent to the raised outer edge 14. A top plate wire cavity 18 penetrates the top plate 12 and is arranged thinner than the thickened ledge 16. A plurality of pressure application cylinders 20 is arranged on the thickened ledge 16.

A bottom plate 22 is joined to the top plate 12, and further comprises a peripheral wall ledge 24. A plurality of sensor location cavities 26 is arranged on the peripheral wall ledge 24. A bottom plate wire cavity 28 penetrates the bottom plate 21 and is arranged thinner thin the peripheral wall ledge 24.

A plurality of resistive force measurement sensors 30 is arranged between the plurality of sensor location cavities 26 and the plurality of pressure application cylinders 20. A battery 32 is arranged between the top plate wire cavity 18 and the bottom plate wire cavity 28.

A microprocessor 34 is electrically coupled to the plurality of pressure application cylinders 20 and to the battery 32. The microprocessor 34 is communicatively coupled to the plurality of resistive force measurement sensors 30. The microprocessor 34 is communicatively coupled to a communication device 36 and programmed with instructions to perform the following steps. First measure an array of force measurements with respect to time from the plurality of pressure application cylinders 20. Then, communicate the array of force measurements to the communication device 36.

In some embodiments a signal conditioning circuit 38 is electrically coupled to the plurality of resistive force measurement sensors 30. A first voltage regulator 40 is electrically coupled to the signal conditioning circuit 38 and configured to provide a reference voltage 42. At least one operational amplifier 44 is electrically coupled to the first voltage regulator 40, a second voltage regulator 46, and one of the plurality of resistive force measurement sensors 30. Measuring a difference between the reference voltage 42 and a second voltage 48 from the second voltage regulator 46 determines the pressure on the one of the plurality of resistive force measurement sensors 30.

In some embodiments, a top plate opening 50 is arranged through the top plate 12. A bottom plate opening 52 is arranged through the bottom plate 22. A top compression'bolt 54 is joined through the top plate opening 50. A bottom nut 56 is arranged against the bottom plate opening 52. The top compression bolt 54 is joined to the bottom nut 56 in order to operatively connect the top plate 12 to the bottom plate 22. The top plate 12 and the bottom plate 22 are operatively connected such that the top plate 12 can separate from the bottom plate 22 a distance of at least one ten thousandth of one inch but no more than one hundredth of one inch. In some embodiments, the raised outer edge 14 operatively surrounds the peripheral wall ledge 24 in order to prevent lateral movement of the top plate 12 and the bottom plate 22.

In some embodiments, the plurality of pressure application cylinders 20 further comprises a lateral heel pressure application cylinder 58, arranged in a lateral heel pressure application cylinder cavity 60. The plurality of sensor location cavities 26 further comprises a lateral heel sensor location cavity 62. A lateral heel resistive force measurement sensor 64 is arranged in the lateral heel sensor location cavity 62. The lateral heel resistive force measurement sensor 64 is electrically coupled to the at least one operational amplifier 44.

In sonic embodiments, the plurality of pressure application cylinders 20 further comprises a caudal heel pressure application cylinder 66, arranged in a caudal heel pressure application cylinder cavity 68. The plurality of sensor location cavities 26 further comprises a caudal heel sensor location cavity 70. A caudal heel resistive force measurement sensor 72 is arranged in the caudal heel sensor location cavity 70, Me caudal heel resistive force measurement sensor 72 is electrically coupled to the. at least one operational amplifier 44.

In some embodiments, the caudal heel sensor location cavity 70 further comprises a caudal heel sensor location top edge 74 arranged on a caudal heel sensor location top edge axis 76. The bottom plate 22 further comprises a bottom plate wire cavity caudal heel axis 78. A caudal heel sensor location cavity angle 80 is measured clockwise from the caudal heel Sensor location top edge axis 76 to the bottom plate wire cavity caudal heel axis 78. The caudal heel sensor location cavity angle 80 is at least five degrees but no more than thirty degrees.

In some embodiments, the plurality of pressure application cylinders 20 further comprises a medial heel pressure application cylinder 82, arranged in a medial heel pressure application cylinder cavity 84. The plurality of sensor location cavities 26 further comprises a medial heel sensor location cavity 85. A medial heel resistive force measurement sensor 86 is arranged in the medial heel sensor location cavity 85. The medial heel resistive force measurement sensor 86 is electrically coupled to the at least one operational amplifier 44.

In some embodiments, the plurality of pressure application cylinders 20 further comprises a frog pressure application cylinder 88, arranged in a tree pressure application cylinder cavity 90. The plurality of sensor location cavities 26 further comprises a frog sensor location cavity 92. A frog resistive force measurement sensor 94 is arranged in the frog sensor location cavity 92. The frog resistive force measurement sensor 94 is electrically coupled to the at least one operational amplifier 44.

In some embodiments, the plurality of pressure application cylinders 20 further comprises a lateral quarter pressure application cylinder 96, arranged in a lateral quarter pressure application cylinder cavity 98. The plurality of sensor location cavities 26 further comprises: a lateral quarter sensor location cavity 100. A lateral quarter resistive force measurement sensor 102 is arranged in the lateral quarter sensor location cavity 100. The lateral quarter resistive force measurement sensor 102 is electrically coupled to the at least one operational amplifier 44.

In some embodiments, the lateral quarter sensor location cavity 100 further comprises a lateral quarter sensor location top edge 103 arranged on a lateral quarter sensor location top edge axis 104. The bottom plate 22 further comprises a bottom plate wire cavity lateral quarter axis 106. A lateral quarter sensor location cavity angle 108 is measured clockwise from the lateral quarter sensor location top edge axis 104 to the bottom plate wire cavity lateral quarter axis 106. The lateral quarter sensor location cavity angle 108 is at least five degrees but no more than thirty degrees.

In some embodiments, the plurality of pressure application cylinders 20 further comprises a medial quarter pressure application cylinder 110, arranged in a medial quarter pressure application cylinder cavity 112. The plurality of sensor location cavities 26 further comprises: a medial quarter sensor location cavity 114. A medial quarter resistive force measurement sensor 116 is arranged in the medial quarter sensor location cavity 114. The medial quarter resistive force measurement sensor 116 is electrically coupled to the at least one operational amplifier 44.

In some embodiments, the medial quarter sensor location cavity 114 further comprises a medial quarter sensor location top edge 118 arranged on a medial quarter sensor location top edge axis 120. The bottom, plate 22 further comprises a bottom plate wire cavity medial quarter axis 122. A medial quarter sensor location cavity angle 124 is measured clockwise from the medial quarter sensor location top edge axis 120 to the bottom plate wire cavity medial quarter axis 122. The medial quarter sensor location cavity angle 124 is at least five degrees but no more than thirty degrees.

In some embodiments, the plurality of pressure application cylinders 20 further comprises a lateral toe pressure application cylinder 126, arranged in a lateral toe pressure application cylinder cavity 128. The plurality of sensor location cavities 26 further comprises a lateral toe sensor location cavity 130. A lateral toe resistive force measurement sensor 132 is arranged in the lateral toe sensor location cavity 130. The lateral toe resistive force measurement sensor 132 is electrically coupled to the at least one operational amplifier 44.

In some embodiments, the plurality of pressure application cylinders 20 further comprises a dorsal toe pressure application cylinder 134, arranged in a dorsal toe pressure application cylinder cavity 136. The plurality of sensor location cavities 26 further comprises a dorsal toe sensor location cavity 138. A dorsal toe resistive force measurement sensor 140 is arranged in the dorsal toe sensor location cavity 138. The dorsal toe resistive force measurement sensor 140 is electrically coupled to the at least one operational amplifier 44.

In some embodiments, the dorsal toe sensor location cavity 138 further comprises a dorsal toe sensor location top edge 142 arranged on a dorsal toe sensor location top edge axis 144. The bottom plate 22 further comprises a bottom plate wire cavity dorsal toe axis 146. A dorsal toe sensor location cavity angle 148 is measured clockwise from the dorsal toe sensor location top edge axis 144 to the bottom plate wire cavity dorsal toe axis 146. The dorsal toe sensor location cavity angle 148 is at least five degrees but no more than thirty degrees.

In some embodiments, the plurality of pressure application cylinders 20 further comprises a medial toe pressure application cylinder 150 arranged in a medial toe pressure application cylinder cavity 152. The plurality of sensor location cavities 26 further comprises a medial toe. sensor location cavity 154. A medial toe resistive force measurement sensor 156 is arranged in the medial toe sensor location cavity 154. The medial toe resistive force measurement sensor 156 is electrically coupled to the at least one operational amplifier 44.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1%, of the actual desired value of any variable, element or limit set forth herein.

All references throughout this application, for example patent documents including issued or granted patents or equivalents, patent application publications, and non-patent literature documents or other source. material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, ¶6. In particular, any use of “step of” in the claims is not intended to invoke the provision of 35 U.S.C. § 112, ¶6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A hoof pressure measuring system, configured to communicate pressure of a horse's hoof; the hoof pressure measuring system comprising:
a top plate, further comprising:
a raised outer edge,
a thickened ledge, adjacent to the raised outer edge,
a top plate wire cavity, penetrating the top plate, and arranged thinner than the thickened ledge;
a plurality of pressure application cylinders arranged on the thickened ledge; a bottom plate, joined to the top plate, and further comprising:
a peripheral wall ledge;
a plurality of sensor location cavities, arranged on the peripheral wall ledge;
a bottom plate wire cavity, penetrating the bottom plate, and arranged thinner than the peripheral wall ledge;
a plurality of resistive force measurement sensors arranged between the plurality of sensor location cavities and the plurality of pressure application cylinders arranged;
a battery, arranged between the top plate wire cavity and the bottom plate wire cavity;
a microprocessor, electrically coupled to the battery and communicatively coupled to the plurality of resistive force measurement sensors; wherein the microprocessor is communicatively coupled to a communication device and programmed with instructions to:
measure an array of force measurements with respect to time from the plurality of pressure application cylinders;
communicate the array of force measurements to the communication device.

2. The hoof pressure measuring system of claim 1, further comprising:
a signal conditioning circuit, electrically coupled to the plurality of resistive force measurement sensors;
a first voltage regulator electrically coupled to the signal conditioning circuit and configured to provide a reference voltage;
at least one operational amplifier, electrically coupled to the first voltage regulator, a second voltage regulator, and one of the plurality of resistive force measurement sensors;
wherein measuring a difference between the reference voltage and a second voltage from the second voltage regulator determines the pressure on the one of the plurality of resistive force measurement sensors.

3. The hoof pressure measuring system of claim 2, further comprising:
a top plate opening arranged through the top plate;
a bottom plate opening arranged through the bottom plate;
a top compression bolt, joined through the top plate opening;
a bottom nut, arranged against the bottom plate opening;
wherein the top compression bolt is joined to the bottom nut in order to operatively connect the top plate to the bottom plate.

4. The hoof pressure measuring system of claim 3, wherein the top plate and the bottom plate are operatively connected such that the top plate can separate from the bottom plate a distance of at least one ten thousandth of one inch but no more than one hundredth of one inch.

5. The hoof pressure measuring system of claim 4, wherein the raised outer edge, operatively surrounds the peripheral wall ledge in order to prevent lateral movement of the top plate and the bottom plate.

6. The hoof pressure measuring system of claim 2,
wherein the plurality of sensor location cavities further comprises: a lateral heel pressure application cylinder cavity;
a lateral heel pressure application cylinder, arranged in the lateral heel pressure application cylinder cavity;
wherein the plurality of sensor location cavities further comprises: a lateral heel sensor location cavity;
a lateral heel resistive force measurement sensor, arranged in the lateral heel sensor location cavity;
wherein the lateral heel resistive force measurement sensor is electrically coupled to the at least one operational amplifier.

7. The hoof pressure measuring system of claim 6,
wherein the plurality of sensor location cavities further comprises: a caudal heel pressure application cylinder cavity;
a caudal heel pressure application cylinder, arranged in the caudal heel pressure application cylinder cavity;
wherein the plurality of sensor location cavities further comprises; a caudal heel sensor location cavity;
a caudal heel resistive force measurement sensor, arranged in the caudal heel sensor location cavity;
wherein the caudal heel resistive force measurement sensor is electrically coupled to the at least one operational amplifier.

8. The hoof pressure measuring system of claim 7, wherein the caudal heel sensor location cavity further comprises:
a caudal heel sensor location top edge arranged on a caudal heel sensor location top edge axis;
wherein the bottom plate further comprises a bottom plate wire cavity lateral quarter axis;
wherein a caudal heel sensor location cavity angle, is measured clockwise from the caudal heel sensor location top edge axis to the bottom plate wire cavity lateral quarter axis;
wherein the caudal heel sensor location cavity angle is at least five degrees but no more than thirty degrees.

9. The hoof pressure measuring system of claim 7,
wherein the plurality of pressure application cylinders further comprises a medial heel pressure application cylinder, arranged in a medial heel pressure application cylinder cavity;
wherein the plurality of sensor location cavities further comprises; a medial heel sensor location cavity;
a medial heel resistive force measurement sensor, arranged in the medial heel sensor location cavity;
wherein the medial heel resistive force measurement sensor is electrically coupled to the at least one operational amplifier.

10. The hoof pressure measuring system of claim 9,
wherein the plurality of pressure application cylinders further comprises a frog pressure application cylinder, arranged in a frog pressure application cylinder cavity
wherein the plurality of sensor location cavities further comprises: a frog sensor location cavity;
a frog resistive force measurement sensor, arranged in the frog sensor location cavity;
wherein the frog resistive force measurement sensor is electrically coupled to the at least one operational amplifier.

11. The hoof pressure measuring system of claim 10,
wherein the plurality of pressure application cylinders further comprises a lateral quarter pressure application cylinder, arranged in a lateral quarter pressure application cylinder cavity
wherein the plurality of sensor location cavities further comprises: a lateral quarter sensor location cavity;
a lateral quarter resistive force measurement sensor, arranged in the lateral quarter sensor location cavity;
wherein the lateral quarter resistive force measurement sensor is electrically coupled to the at least one operational amplifier.

12. The hoof pressure measuring system of claim 11, wherein the lateral quarter sensor location cavity further comprises;
a lateral quarter sensor location top edge arranged on a lateral quarter sensor location top edge axis;
wherein the bottom plate further comprises a bottom plate wire cavity lateral quarter axis;
wherein a lateral quarter sensor location cavity angle is measured clockwise from the lateral quarter sensor location top edge axis to the bottom plate wire cavity lateral quarter axis;
wherein the lateral quarter sensor location cavity angle is at least five degrees but no more than thirty degrees.

13. The hoof pressure measuring system of claim 11,
wherein the plurality of pressure application cylinders further comprises a medial quarter pressure application cylinder, arranged in a medial quarter pressure application cylinder cavity;
wherein the plurality of sensor location cavities further comprises: a medial quarter sensor location cavity;
a medial quarter resistive force measurement sensor, arranged in the medial quarter sensor location cavity;
wherein the medial quarter resistive force measurement sensor is electrically coupled to the at least one operational amplifier.

14. The hoof pressure measuring system of claim 13, wherein the medial quarter sensor location cavity further comprises:
wherein the plurality of pressure application cylinders further comprises a medial quarter pressure application cylinder, arranged in a medial quarter pressure application cylinder cavity;
wherein the bottom plate further comprises a bottom plate wire cavity medial quarter axis;
wherein a medial quarter sensor location cavity angle is measured clockwise from the medial quarter sensor location top edge axis to the bottom plate wire cavity medial quarter axis;
wherein the medial quarter sensor location cavity angle is at least five degrees but no more than thirty degrees.

15. The hoof pressure measuring system of claim 13,
wherein the plurality of pressure application cylinders further comprises a lateral toe pressure application cylinder, arranged in a lateral toe, pressure application cylinder cavity;
wherein the plurality of sensor location cavities further comprises: a lateral toe sensor location cavity;
a lateral toe resistive force measurement sensor, arranged in the lateral toe sensor location cavity;
wherein the lateral toe resistive force measurement sensor is electrically coupled to the at least one operational amplifier.

16. The hoof pressure measuring system of claim 15,
wherein the plurality of pressure application cylinders further comprises a dorsal toe pressure application cylinder, arranged in a dorsal toe pressure application cylinder cavity;
wherein the plurality of sensor location cavities further comprises: a dorsal, toe sensor location cavity;
a dorsal toe resistive force measurement sensor, arranged in the dorsal toe sensor location cavity;
wherein the dorsal toe resistive force measurement sensor is electrically coupled to the at least one operational amplifier.

17. The hoof pressure measuring system of claim 16, wherein the dorsal toe sensor location cavity further comprises:
a dorsal toe sensor location top edge arranged on a dorsal toe sensor location top edge axis;
wherein the bottom plate further comprises a bottom plate wire cavity dorsal toe axis;
wherein a dorsal toe sensor location cavity angle is measured clockwise from the dorsal toe sensor location top edge axis to the bottom plate wire cavity dorsal toe axis;
wherein the dorsal toe sensor location cavity angle is at least five degrees but no more than thirty degrees.

18. The hoof pressure measuring system of claim 16,
wherein the plurality of pressure application cylinders further comprises a medial toe pressure application cylinder, arranged in a medial toe pressure application cylinder cavity;
wherein the plurality of sensor location cavities further comprises: a medial toe sensor location cavity;
a medial toe resistive force measurement sensor, arranged in the medial toe sensor location cavity;
wherein the medial toe resistive force measurement sensor is electrically coupled to the at least one operational amplifier.
